(19) United States
(12) Patent Application Publication
(10) Pub. No.: US 2006/0031899 A1
(43) Pub. Date: Feb. 9, 2006

(54) Methods for augmenting subscription services with pay-per-use services

(75) Inventors: Michael Rabin, Gates Mills, OH (US); David Pessel, Pepper Pike, OH (US); Peter Kusner, Mayfield Heights, OH (US); Erwin Bruder, Beachwood, OH (US); Benjamin E. Greenberg, Elkins Park, PA (US)

Correspondence Address: DRIGGS, LUCAS, BRUBAKER & HOGG CO., L.P.A., 38500 CHARDON ROAD, DEPT. DLBH, WILLOUGBY HILLS, OH, 44094, US

(73) Assignee: Prepaid Content, Inc., Beachwood, OH (US)

(21) Appl. No.: 11/198,678

(22) Filed: Aug. 5, 2005

Related U.S. Application Data
(60) Provisional application No. 60/599,500, filed on Aug. 6, 2004.
(60) Provisional application No. 60/599,600, filed on Aug. 6, 2004.
(60) Provisional application No. 60/599,601, filed on Aug. 6, 2004.
(60) Provisional application No. 60/599,602, filed on Aug. 6, 2004.

(51) Int. Cl. H04N 7/16; H04N 5/445; H04N 7/173; G06F 3/00; G06F 13/00

(52) U.S. Cl. 725/104; 725/30; 725/60; 725/61; 725/86

(57) ABSTRACT

The present invention provides a method for augmenting subscription services with pay-per-use services. One embodiment of the invention is a method comprising the following steps: providing content on a subscription basis; and providing content on a pay-per-use basis comprising: accepting a token having a unique indicia and a monetary value; providing subscription content; and, reducing the monetary value of the token based upon the value of the provided subscription content.

### REFERENCES TO RELATED APPLICATIONS

This application claims the benefits of and is a continuation-in-part of the following provisional applications previous filed in the United States Patent and Trademark Office, all of which were filed by common inventors Michael Rabin, David Pessel, Peter Kusner and Erwin Bruder, and all of which were filed on Aug. 6, 2004: “User Characteristic Verification Systems and Methods” (Ser. No. 60/599,500); “Methods and Systems for Controlling Access to Restricted Content” (Ser. No. 60/599,600); “Methods for Augmenting Subscription Services with Pay-Per-Use Services” (Ser. No. 60/599,601); and “Methods and Systems for Controlling Access to Restricted Content” (Ser. No. 60/599,602).

### TECHNICAL FIELD

The present invention relates to methods for augmenting subscription services with pay-per-use services and more particularly to augmenting subscription services with pay-per-use services through the use of a token having a unique indicia and a predetermined monetary value.

### BACKGROUND

Communication and information services such as the Internet and cable television offer users access to a vast amount of content. This content may be in the form of data files that include text, image, audio, video, documents, streaming media, software, or any other elements of data. Users seek this content for a variety of purposes, including research and entertainment.

Content providers seeking to capitalize upon content market demand have experimented with a variety of business models. One popular method requires users to register prior to gaining access to premium or restricted Internet content. Another method, popular in the cable industry, requires users to subscribe to restricted content. The registration and subscription processes typically require that a user provide identification information such as the user's name and address and sensitive financial information such as credit card account numbers. A significant number of Internet users seriously dislike the idea of providing such information due concerns about privacy and security, especially when users seek only one-time access from particular content provider.

This problem is further compounded by the fact that each content provider often requires a separate registration or subscription. A single user wishing to access restricted content provided by multiple content providers must establish accounts with each content provider, thereby requiring the dissemination of sensitive information to multiple entities. Additionally, some users are simply unable to establish such accounts. Given these inconveniences and concerns, many users choose not to access otherwise desirable restricted content.

Some content providers currently offer pay-per-use access to restricted content. For example, Reed Elsevier's lexisONE® website offers access to some content at no charge. However, lexisONE® allows users to access restricted content on a pay-per-use basis. This is accomplished by requiring users to pay a charge via credit card in order to view restricted content. This method does have some disadvantages for content providers. An account must be created for each user seeking one-time access. Every time a user views restricted content, the content provider incurs expenses, such as credit card processing fees. Content providers also must incur equipment or rental costs associated with storing data for each user. Given these disadvantages, many content providers choose not to provide restricted content on a pay-per-use basis, but only on a subscription basis. Users often characterize subscriptions as disadvantageous. Some subscriptions automatically renew making cancellation of a subscription more difficult. Further, some subscriptions have minimum subscription period requirements that far exceed a user's individual needs.

### SUMMARY

The present invention provides a method for augmenting subscription services with pay-per-use services. One embodiment of the invention is a method comprising the following steps: providing content on a subscription basis; and providing content on a pay-per-use basis comprising: accepting a token having a unique indicia and a monetary value; providing subscription content; and, reducing the monetary value of the token based upon the value of the provided subscription content.

### BRIEF DESCRIPTION OF THE DRAWINGS

FIG. 1 is a schematic representation of a method for authenticating the validity of an inputted unique indicia and monitoring usage according to the present invention.

FIG. 2 is an internet web browser view according to the present invention.

FIG. 3 is an internet web browser view according to the present invention.

FIG. 4 is an internet web browser view according to the present invention.

FIG. 5 is plan view of a computer-readable medium or carrier comprising an embodiment of the present invention tangibly embodied in a computer program residing thereon.

FIG. 6 is a schematic representation of a method for distributing tokens according to the present invention.

FIG. 7 is a schematic representation of a system for controlling content access according to the present invention.

FIG. 8 is a schematic representation of a control system as a proxy between a content provider and a user's personal computer according to the present invention.

FIG. 9 is a schematic representation of a system for authorizing access to restricted content according to the present invention.

FIG. 10 is a schematic representation of an authentication process according to the present invention.

FIG. 11 is a schematic representation of a physical token in accordance with the present invention.

### DETAILED DESCRIPTION

The following detailed description sets forth preferred embodiments for methods for augmenting subscription services with pay-per-use services. This description should not be interpreted as limiting the use of the invention to this particular application. Further, reference is made to the accompanying drawings and figures, which, in conjunction with this detailed description, illustrate and describe the methods converting subscription services to pay-per-use services. The invention may be embodied in many different forms and should not be construed as limited only to the disclosed embodiments.

The present invention may be utilized for various functions including controlling access to subscription television content, subscription radio content, DVD access control, rental game control and software rental, whether the software runs on a personal computer, a network such as an intranet or Internet, or a combination of both. The present disclosure also describes methods and systems for controlling access to restricted content.

The term content as it is used herein should be broadly interpreted to include text, images, audio files, video files, documents, streaming media, software or any other element of data storage. The term restricted can include restrictions based upon age, geographic location, membership, or any other predetermined user characteristic or can simply mean restricted to registered users or to paying users. The term communications link should be broadly defined to include any means of communication between two physical objects. The term restricted may also apply to any content that is not generally accessible by the public.

In one embodiment of the present invention, an Internet content provider provides restricted content to users that have registered and subscribed. Registration involves transmitting data to the content provider and receiving login information in exchange. For example, an Internet content provider may offer restricted or premium content to users that have registered by providing identification information and financial information. The Internet content provider then electronically stores that identification information and financial information. Such information as it is associated with a single user may be referred to as an account. Successful content providers may have millions of such accounts. Subscription involves choosing the payment basis upon which user will access restricted content. A user may subscribe on a yearly basis meaning that the user will pay a set fee for one year of access to restricted content.

Registered subscribing users seeking to access the content provider's restricted content must login to the content provider's website. Logging in is characterized as submission and verification of identification information such as a user id and a password. Once logged in, the user is able to view restricted content.

In accordance with the present invention, a subscription content provider also provides content on a pay-per-use basis. A user obtains a token having a unique indicia and a predetermined monetary value. The unique indicia is then presented for verification or authentication. Assuming the unique indicia is authenticated, login information is provided ultimately to the content provider. It can be provided in the same manner that a registered user logs in to the content provider's website. Restricted content is then provided to the user. Once logged in, the monetary value associated with the token is reduced based upon the value of the provided subscription content. The pay-per-use content is the same content a subscription user would be provided, if the subscription user requested the same content.

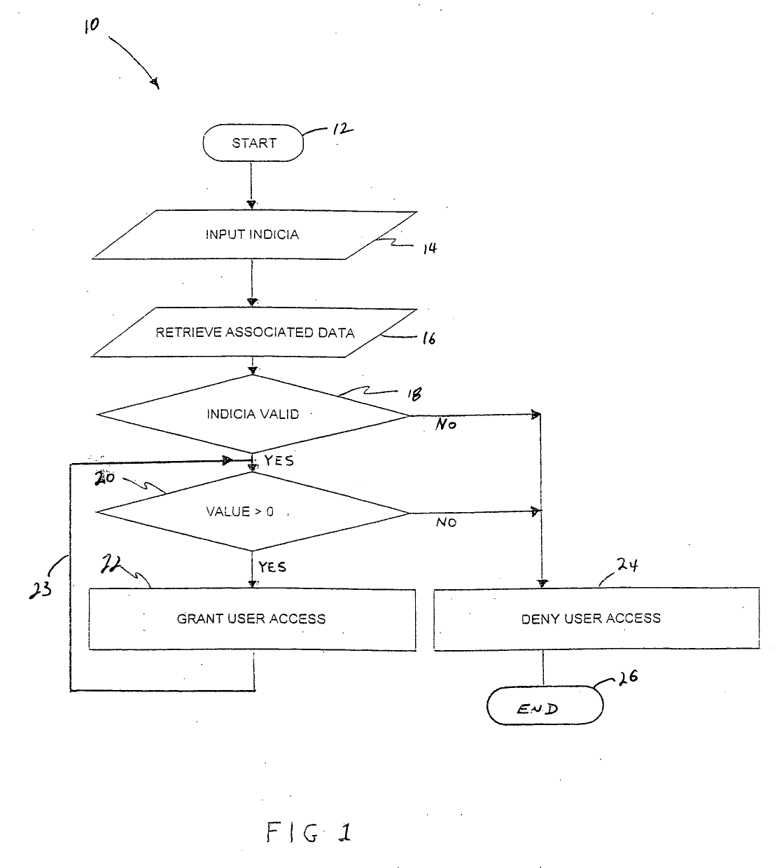

FIG. 1 is a schematic representation of a computerized embodiment of the method for authenticating the validity of an inputted unique indicia and monitoring usage. Once a user initiates 12 the authentication/monitoring process 10, the user inputs 14 the unique indicia. The unique indicia 14 is then associated 16 with the token value. Inherent in this association process 16 is a determination 18 of whether or not the inputted unique indicia is valid. If it is not, the authentication process denies the user access 24 and ends 26. If, however, the indicia is valid, a determination is made as to whether the value of the token is greater than zero. If not, the authentication/monitoring process 10 denies the user access 24 and ends 26. Alternatively, the authentication/verification process 10 may prompt the user to input a second unique indicia. In yet another embodiment, the authentication process 10 may give the user the option of inputting a credit card number to increase the value of the token. The authentication/monitoring process includes, when required, checking any additional restrictions that the content provider places on access to their content, such as age or geographic location. This additional restriction verification step may be performed during the indicia validation determination 18. Assuming the value of the token is greater than zero, the authentication/verification process 10 will grant the user access to the subscription content on a pay-per-use basis. Access is granted by granting the user access under an account configured as a standard subscription account.

During the authentication/verification process 10, a user may be presented with different per-use payment options. For example, a user may select to pay based upon a per-minute, per-day, per-week, per-month, or per-transaction basis. Examples of transactions include print commands, download and save commands, view commands, and other user initiated commands.

The user's content usage is monitored 23. In turn, the monetary value of the token is reduced based upon the value of the provided subscription content. Once the value of the token becomes equal to or less than zero, the authentication/verification process 10 terminates the user's access to the content. Optionally, the authentication/verification process 10 may prompt the user to enter a second unique indicia 44. In one embodiment, the authentication/verification process 10 makes a determination every minute as to whether the user is still viewing restricted content. This determination is made by the authentication/verification process every minute and the monetary value of the token is immediately reduced based thereon. Alternative intervals of monitoring usage are contemplated. For example, usage information may be monitored in real time.

It is to be understood that the term “content provider” as used in this application is to be construed broadly as any subscription content provider that restricts access to content. Examples of content providers include Internet or intranet websites; network computer servers and services; telephone, wireless, cellular and Wi-Fi access or content providers; and cable, pay-per-view, satellite and other restricted media services. Other types of content providers will be readily apparent, and the present intention is not restricted to the illustrative examples described herein. The term “token” as utilized in the present application is to be understood as a form or tangible expression of intermediary's access code where the intermediary's token allows the user access to subscription services on an alternative or pay-per-use basis.
WEBSITE REGISTRATION. In another aspect of the present invention a content provider website may provide the intermediary with certain information. Examples include name, tax ID, pay-to address, subscription content provider url. In one embodiment of the invention this is done with a web-based form that prompts the content provider owner or content provider representative for the required information
CONTENT PROVIDER BASE PRICING. In another aspect of the present invention a content provider provides the intermediary with one or more methods of charging where the content provider chooses either a base rate to enter subscription area (e.g., $1/hr) or a base rate for download (e.g., $1/download), or a combination thereof. A base rate may also be applied to “events” such as email contact, instant messaging, voice over ip, video, etc. or any other digital process involving transmission and/or receipt of data
CONTENT PROVIDER UPSELL PRICING. In another aspect of the present invention a content provider may also provide sub-domains, directories, file types, and/or specific urls within the subscription area where the base rate(s) do not apply but rather other rates apply: examples of rate include $2/download, $10/hr, and $1/min.. Any base rates may be supported, with examples including per second charge and/or a per byte charges, and combinations of minutes, bytes, and/or downloads or measures such as email transmission or receipt, instant message transmission or receipt or other forms of communications on the internet;
CONTENT PROVIDER VARIABLE PRICING. In another aspect of the present invention one or more rate matrices may also be described by content providers where price varies by time, similar to phone companies and/or by demand similar to airline seats; price may also be determined by demand as in auction where content is provided to one or more users that have bid the highest for the subscription area or other restricted area on a network where certain content is stored is provided by a gateway such as a live video feed
CONTENT PROVIDER UPDATE TO INCLUDE INTERMEDIARY LOGO AND LINK. In another aspect of the present invention a website content provider may place an intermediary's logo and unique link at one or more places on an area of a subscription content provider website. In one embodiment of the present intention this is done by the intermediary emailing to the content provider lines of web-based code that contains logo, link, and other control code; content provider then inserts these lines of code in at least one page on the content provider in a free area of the content provider;
ALTERNATIVE TO CONTENT PROVIDER UPDATE WITH LOGO AND LINK. In another embodiment of the present invention, a content provider does not place intermediary's logo and link on the content provider website, but rather the user is notified of a content provider's ability to accept intermediary's method of access when consumer hits the content provider website or one or more specific urls within the content provider website. This may be accomplished by having a domain lookup process active on the user's machine, such as in the user's operating system or user's browser; alternatively, the content provider participation in the lookup process may be completely web-based, where the user browses content providers through the intermediary's web process.
ESTABLISHING INTERMEDIARY'S ACCESS TO SUBSCRIPTION AREA. In another aspect of the present invention a content provider may provide to an intermediary one or more sets of credentials to enter a subscription area (e.g., username/password sets); optionally, in addition, or as an alternative, a content provider may provide to an intermediary other access by network protocols such as a “pinhole” in firewall; as another alternative, an intermediary may purchases one or more sets of credentials from the content provider using the content provider's standard “purchase subscription” interface.

ONLINE CONSUMER ACCESS. In another aspect of the present invention a user may click an intermediary's logo at a desired content provider internet website, as an alternative to subscription, to either learn more, enter an intermediary access code (using “unique indicia” language; typically numeric but may be alphanumeric or alpha) or buy an intermediary access code. If a user has an intermediary access code and wishes to enter the subscription area, then the user supplies the intermediary access code when prompted and supplies other relevant or required information: illustrative examples include a security code or private code which is a smaller numeric or alphanumeric or alpha code associated with the intermediary access code that is known to only the user and the intermediary. A security code may be the last four or other specified number of digits of the code, or some other part of the code: thus in another aspect of the present invention as a convenience to the user, the user may only be required to enter this smaller partial-code number to enter the website provided that the user verifies the larger code when prompted. Alternatively, if an intermediary logo is not present, then a user may be prompted with the choices described above upon entering a desired content provider website, provided that the website participation lookup described above is active on user's machine or via an alternative web-based process.

ACCESS CODE PURCHASE. In another aspect of the present invention if a user desires to purchase an intermediary access code then the user may purchase the code either directly from the intermediary or from another third-party code provider or retailer. Said intermediary access code may be purchased in a number of ways: for example, onlineor in the form of a stored value code such as a prepaid code from Starbucks or other retailer, provided that intermediary has business relationship with other said third-party code provider. Examples of online options include credit card sales, or through Internet accounts such as Paypal™ or Epassporte™ or any other payment type available online. In another aspect of the present invention a content provider may agree to a business relationship with the intermediary that applies to code purchases for use at that content provider; in one embodiment of this type of agreement a user must agree to intermediary's terms of use for the code and user will be informed of any restrictions that may apply to use of the code at other content providers. In one embodiment of the present invention a single access code may give a user access to multiple subscription content providers, provided that the code has sufficient remaining value upon entering each content provider: this provides advantages to the user in that it enables him to register once and then access many unrelated content providers while bypassing multiple registration processes. A user may also purchase an intermediary access code from an intermediary entity via automated or live telephone process where user supplies payment information over the phone. Alternatively a user may also purchase an intermediary access code at a physical retail location; in one aspect of the present invention retailer identification may be provided through an online Internet browser interface which prompts the user to entera preferred zip code to locate nearest store or other retail establishment. In another aspect of the present invention a user may also obtain a code from certain advertisements and/or promotions that may be included in newspapers, magazines, other hardcopy publications, or even online promotions and/or advertisements where such codes are provided for free by content providers or others in order to promote use of the code.

INTERMEDIARY DOUBLE PROXY TECH. PLATFORM. One skilled in the art will recognize that a “Prepend-URL proxy” may also be utilized at the present invention in order to eliminate the need for any consumer-side setup: any standard browser on any standard operating system at any network location public or private will work. In such an embodiment of the present invention the Prepend-URL proxy is configured to communicate with intermediary entity's main “proxy” computer system that connects consumer to subscription content provider.

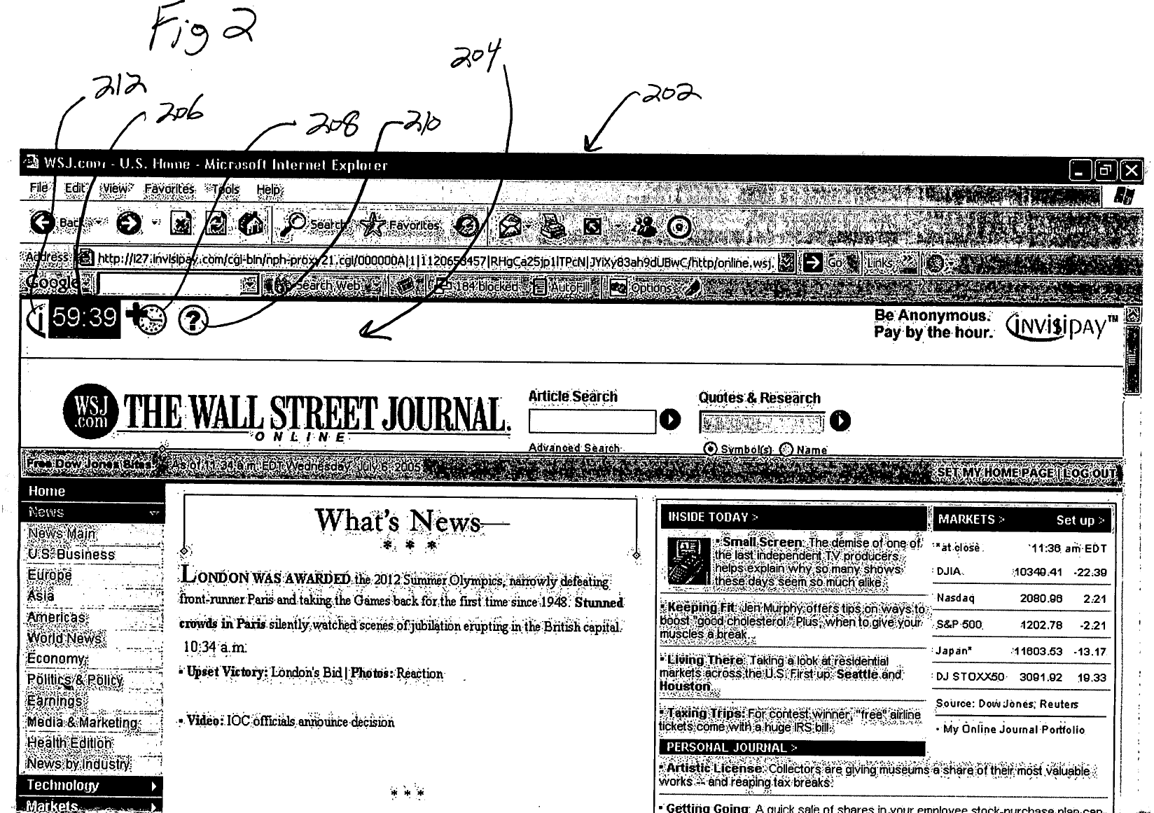

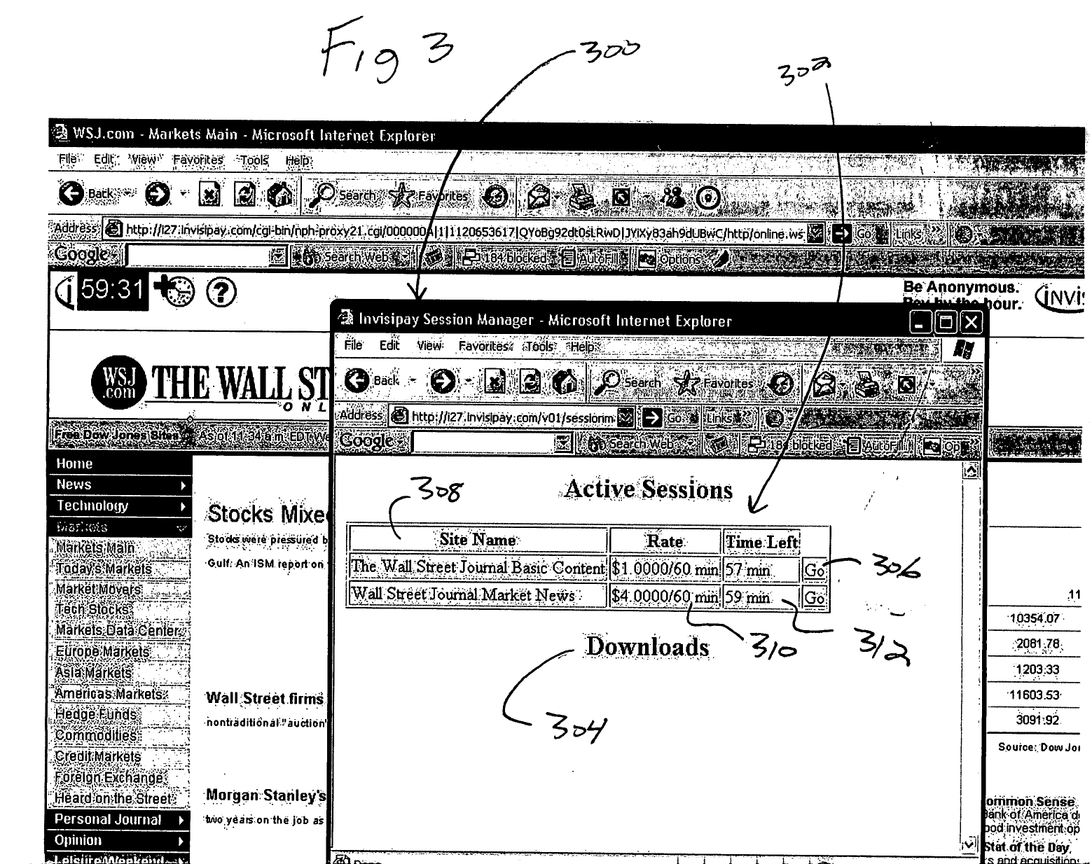

INTERMEDIARY TOOLBAR. In another aspect of the present invention an “intermediary toolbar” is provided for use with a user's browser. Referring now to FIG. 2, an exemplary browser window 202 is illustrated. While a consumer is connected to a subscription internet website (such as the Wall Street JournalD Online web site illustrated in browser window 202) via an intermediary access according to the present invention, the intermediary's toolbar 204 is displayed. In the present embodiment the toolbar 204 provides a clock 206 which provides a real-time display of the amount of subscription content access time remaining through the use of the intermediary access. The toolbar 204 also provides other consumer functionality, such as an “add time” button 208 which enables the user to contact the intermediary entity and purchase additional time for subscription content access; a “help” button 210 and “session manager” “i” icon button 212 are also provided. When a user clicks on the ‘i’ icon button 212 a session manager screen window 300 illustrated in FIG. 3 is provided that displays an interactive session list 302 and a download list 304. Help and control functions are also provided. By clicking on one of the “go” buttons 306 the user's browser will be redirected to the associated active session as provided in the site name list 308. The active session list 302 also identifies an access rate 310 associated with any particular active session, as well as giving time-remaining information 312.

In addition, the physical area on the browser display screen may be used to display certain advertising and/or other marketing information specific to the particular website, specific to the retailer that sold the code, other retailer or retailers that may have a business relationship with the intermediary and/or the website and wish to advertise.

INTERMEDIARY SINGLE PROXY TECH. PLATFORM. Consumer connection to subscription area may also be achieved with a single proxy; in this case consumer manually sets a proxy connection and the browser or consumer's browser is automatically set up to connect to intermediary proxy after execution of code on the consumer's computer.

CONTENT PROVIDER-LOCATED TECH. PLATFORM. Consumer connection to subscription area may also be achieved without proxy, but rather with intermediary server located on the same LAN or high-speed bus as the content provider's server or servers and within the content provider's DMZ behind a content provider's firewalls. A user then connects to the subscription area through the intermediary server after being given permission to get through the content provider's firewall(s) to access intermediary server. Intermediary software may also reside on the content provider's server or servers rather than on a separate server.

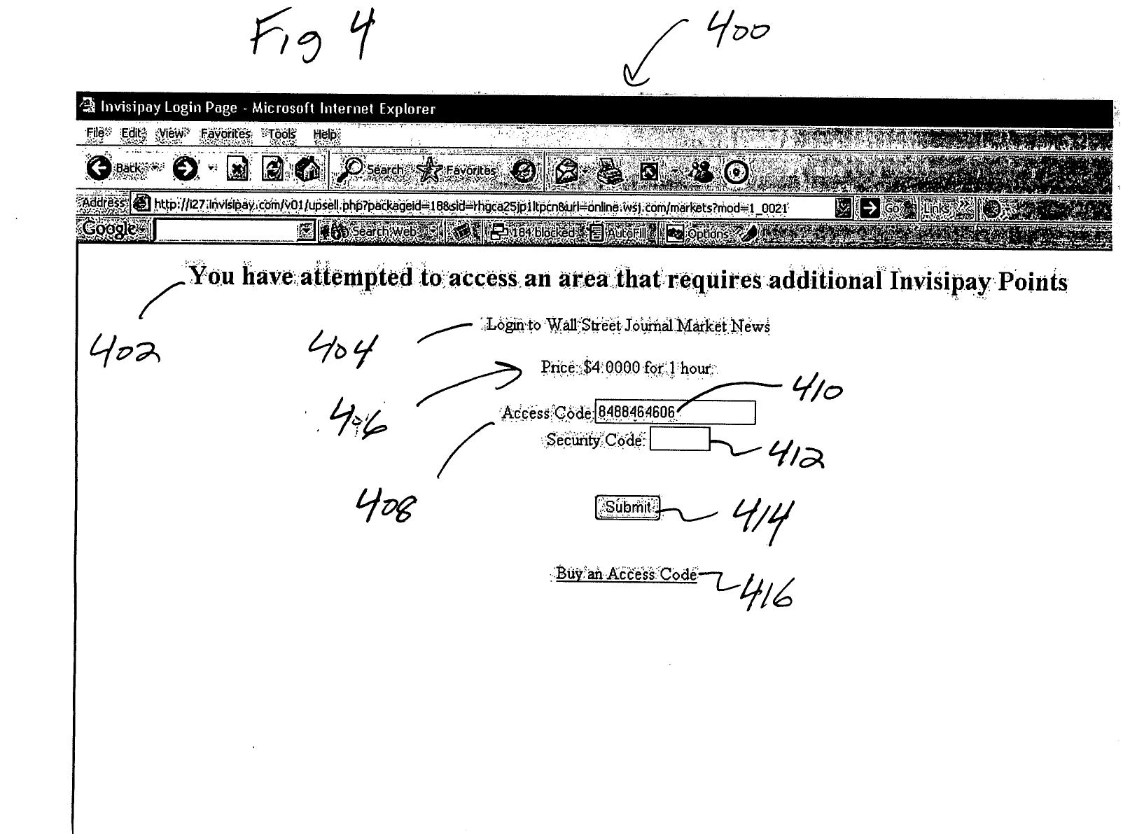

UPSELL METHOD. In another aspect of the present invention a user may click an “upsell link” located in the browser window. An upsell link is generally associated with premium services not included in the present intermediary access agreement being utilized: for example, some content providers may require limit the subscription content available to users accessing through the intermediary or token according to the present invention: the upsell link may accordingly be provided to redirect the user to another browser interface or window, such as the upsell link browser window 400 shown in FIG. 4. The upsell link browser window 400 provides alert information 402 that informs the user that he is attempting to access premium content, identifies the premium content through identification information 404, provides rate information 406 indicating the premium pricing required for access, displays access code information 408 identifying the users present intermediary's token access code 410 and prompts the user to enter and associated security code in hyperlink box 412, which the user must enter in order to agree to accessing the premium content at the higher rate by clicking on the submit button 414. Additionally, the upsell link browser window 400 may provide a hyperlink 416 that will take the user to another browser window or interface that will enable the user to buy more time for subscription content accessed through the present intermediary's token access code 410, or by purchasing another intermediary's token access code.

LOTTERY FUNCTIONS. Another advantage of a user receiving the benefit of anonymous access to subscription content providers according to the present invention is that the intermediary's token access code may be used as a token for entry into various online sweepstakes either conducted by individual subscription content providers, groups of content providers, intermediaries or combinations thereof. It could also be conducted in combination with other stored value accounts (for example, Starbucks, Inc., or Barnes&Noble, Inc. prepaid and/or gift cards, etc.) provided that these other stored value accounts had a particular business relationship and technical interface with intermediary. For example there could be a daily or periodic drawing(s) and monetary or other award based upon the winning token(s) where payout is given by content provider, group of content providers, intermediary, or a combination of payors. A winner could make claim by providing a second number associated with the winning code that is issued at the time of access code purchase (e.g., a secret sweepstakes code). Where intermediary's token access codes are sold on physical cards, a designated area of the physical card may contain a “scratch off” regions hiding contest numbers on the card.

CONTROLLING ACCESS TO RESTRICTED CONTENT. The present invention also relates to methods and systems for controlling content access and more particularly to controlling access to restricted content primarily through the use of a token. Control of access to restricted content is preferably accomplished by providing a token having a unique indicia thereon to a user. The token may be in the form of a physical object and the unique indicia may be in the form of an anonymous access code. The token is “prepaid” in that it has a predetermined monetary value, and a user obtaining the token must pay for it at the point of sale. In one embodiment, the token is in the form of a physical card, similar to both prepaid phone cards and shopping mall gift cards. Alternatively, the prepaid token could be in the form of a computer printout having an anonymous access code imprinted upon it at the point of sale. Alternative means for distributing the prepaid media do presently exist and can be appreciated by one of ordinary skill in the art.

Other embodiments of the token include a prerecorded audio message that could be delivered over conventional and cellular phone systems, and any series of data forming an electronic file transmittable to the consumer over an electronic network, such as a cellular phone network SMS message, computer network instant messaging services, and electronic mail services.

In addition, the token can be distributed in various restricted forms that require verification of a user characteristic, such as residence, age, affiliation, etc. prior to purchase. For example, the retail sales of tokens may be conditioned upon users showing evidence of proper age. The sale of one variety of tokens may be restricted to individuals that are eighteen or older, while others may be limited to individuals who are sixty-five or older. Evidence of proper age may be a driver's license or other photographic identification card. This “carding” age verification technique has long been recognized as effective and efficient.

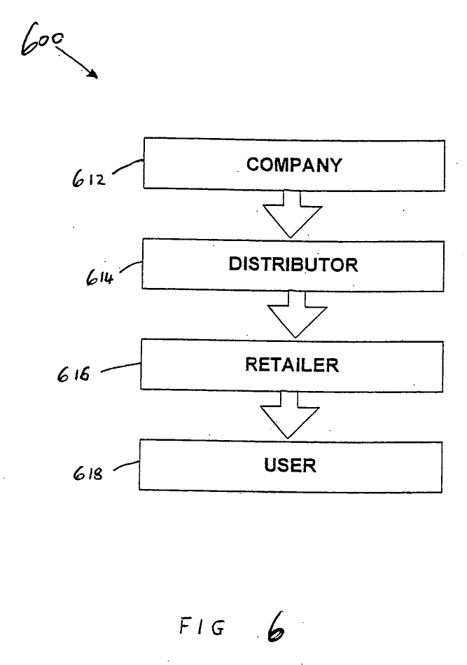

FIG. 6 is a schematic representation of a method 600 for distributing tokens 734 having unique indicia 744 or access code. A company enabling content access 612 sells tokens in bulk to a distributor 614. The distributor 614 then resells tokens to a retailer 616 who then sells a token to a user 618. Alternative methods for distributing tokens do exist and can be appreciated by one of ordinary skill in the art. In one such alternative, a company enabling content access 612 may sell the tokens directly to a retailer 616 who then sells them to users 618. In another alternative, a company enabling content access 612 sells the tokens directly to users 618. In yet another alternative, the tokens may be created, modified, or activated at the point of sale to a user 618. Alternatively, the tokens could be distributed by a third party as a premium included with the purchase of the third party's product, such as a magazine, computer, software, etc.

A token in the form of a premium could take on other embodiments, including being distributed as via electronic means, such as an Internet website, other networked location, cellular phone SMS message, computer network instant message, or electronic mail. Other embodiments are being considered and can be appreciated by one experienced in the art.

These distribution methods offer several benefits to users. One is that the purchase may be made anonymously. Another is that no personal information must be disclosed prior to accessing restricted content.

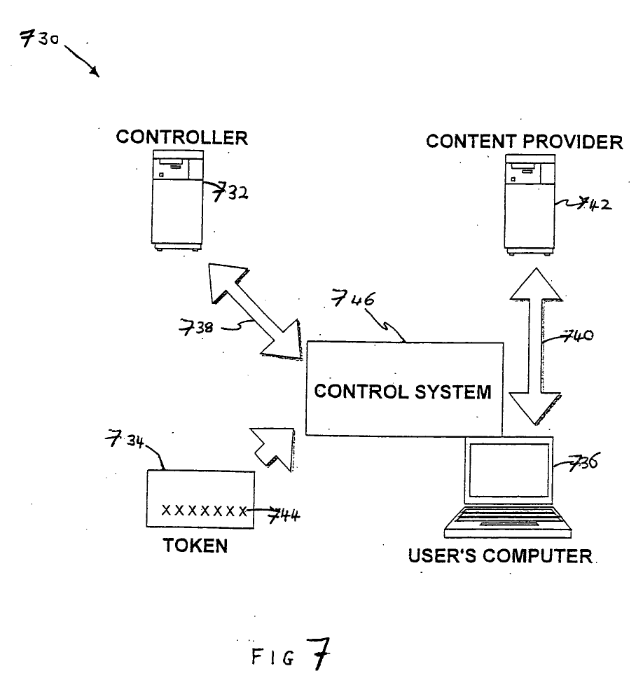

In one preferred embodiment, the method of the present invention is implemented as a computerized system for controlling access to restricted Internet content. FIG. 7 is a schematic representation of such a system 730. To access Internet content, a user 618 must first obtain a token 734 having a unique indicia 744. Provided the user meets any conditions of sale, the retailer will sell the token 734 to the user 618. The user 618 may then use a personal computer 736 to navigate to a content provider's website 742 via a communications link 740 between the user's computer 736 and a content provider's website 742. Alternatively, the user 618 may initiate receipt of restricted cable television content, restricted satellite television content, restricted cable radio content, restricted satellite radio content, restricted cellular phone content, or any other form of restricted electronic content accessible over a network.

The term “personal computer” refers to a desktop computer, laptop computer, personal digital assistant, any form of portable computer, cellular phone, set-top television box, or any electronic device that can access an electronic network. Additionally, the navigation step above may involve navigation to a network location that is preconfigured to act as a gateway to restricted content distributed by the content provider. This gateway may take the form of any remote location accessible by the user. In another form, the gateway may be a software application running on the user's personal computer or a software application running from a networked location.

The user 618 then initiates an authentication or verification process 10 (FIG. 1) through which the unique indicia is verified. This is accomplished by requiring the user 618 to input the unique indicia 744 into a control system 746. Alternative methods of communicating the unique indicia 744 to the control system 746 such as through the use of an iButton® computer chip, smart card, barcode scanner, or RFID signal are contemplated and can be appreciated by one of ordinary skill in the art. The control system 746 may be in the form of a custom Internet browser or viewer software application installed upon the user's computer 736. Alternatively, the control system may be in the form of a controller agent residing on the user's computer 736, an Internet portal or other remote website, or a software application accessible via the content provider's website, a software application accessible via a network, or a software/hardware combination at the content provider's site. The control system 746 transmits the unique indicia 744 to a controller 732, either directly or via a communications link 738. In one embodiment, the controller 732 comprises a remote server having a database and related software. However, alternative embodiments of the controller 732 are currently contemplated and can be appreciated by one of ordinary skill in the art.

In another embodiment, the control system can also take the form of the content provider's website, another preconfigured gateway, or any other remote network location including a website.

Once received, the controller 732 verifies the authenticity of the unique indicia 744. This is accomplished by retrieving certain data associated with the token 734. Such data comprises a monetary value associated with the token. Assuming the value of the token is greater than zero, the controller 732 will return a signal to the control system 746 authorizing the user 618 to access the restricted content (“authorization signal”).

Other data can be associated with the token, such as restrictions based on information given at the time of purchase, such as age or geographic location. Other restrictions may be associated with the token that could be based on demographic data of the purchaser or the type of token purchased. If any of these other restrictions apply to the transmitted token, the control system 746 will check that the restricted content requested satisfies these restrictions before returning the authorization signal.

In one embodiment, the authorization signal comprises login data for a specific content provider. The login data may be dynamic in that it changes for each login or it may be static in that the same login data is used by multiple users to access a particular content provider's restricted content. Once the control system 746 receives the login data, it supplies that data to the content provider 742. The use of the present invention allows users to “login” anonymously.

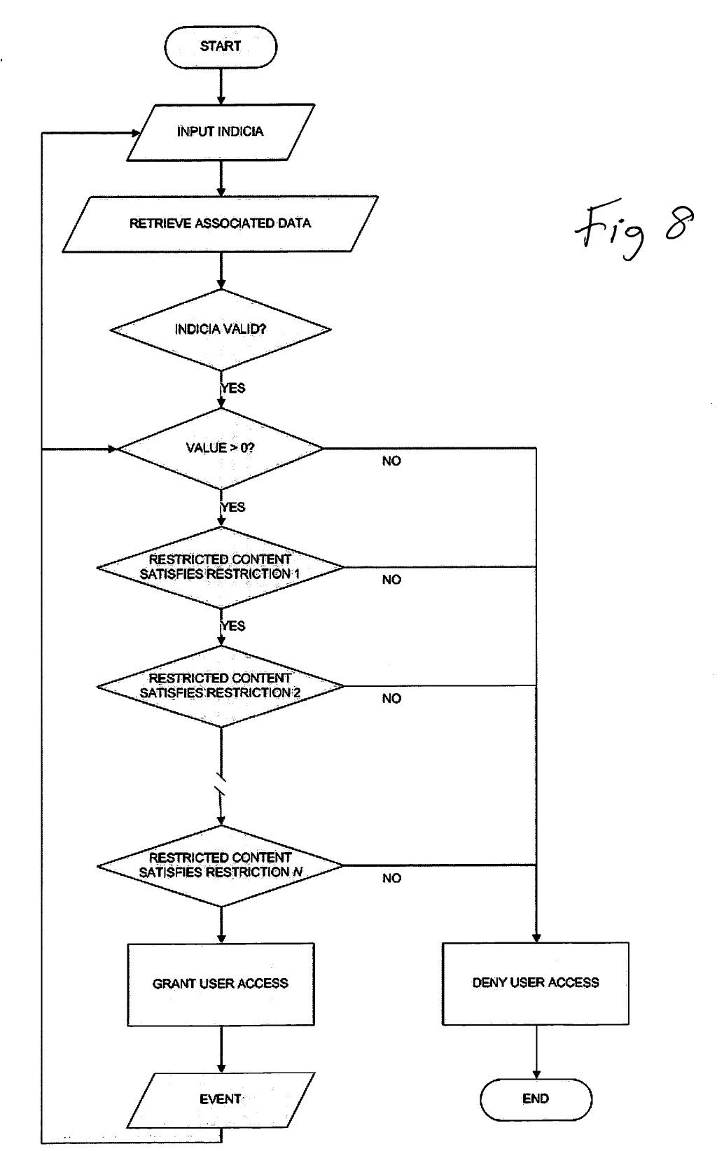

In one embodiment of the invention, shown in FIG. 8, the control system acts as a proxy between the content provider and the user's personal computer. In this embodiment, the signal authorizing access uniquely identifies the user, the restricted content that the user 618 is authorized to access, the content provider where the restricted content resides, and any other restrictions placed on the authorization, such as a time limit or other restriction. The content provider permits access to the content provider's restricted content to the proxy by way of a prearranged agreement. One such agreement may be executed by the content provider allowing the specific network address, such as IP address, of the control system access to the restricted content. In another possible agreement, the control system exchanges prearranged credentials such as a username and password with the restricted content server to allow access. Such credentials may be the same for every user or they may exist as a pool of credentials such that the credentials passed vary for each authorization signal. Other agreements are possible and can be appreciated by one of ordinary skill in the art. This embodiment of the control system may be implemented in the form of a controller agent residing on the user's computer, an Internet portal or other remote website, a software application accessible via the content provider's website, a software application accessible via a network, or a software/hardware combination at the content provider's site. This embodiment of the control system may be designed to accommodate a single user or a plurality of users and may access a single content provider or a plurality of content providers. After receiving the authorization signal, the control system retrieves the restricted content from the content provider via a communications link and transmits it to the user's computer. The restricted content may take the form of interactive data that may contain a plurality of entry points to other restricted content. In this case, when the user invokes an entry point, the control system reexamines the original authorization signal to determine if the user is authorized to access the newly requested restricted content. If so, the control system retrieves the restricted content from the content provider 742 via a communications link and transmits it to the user's computer. If not, the request is denied. The control system may allow the user to enter the unique indicia again and restart the process to obtain a new authorization signal from the controller to authorize access to the newly requested restricted content. The communications link may be in the embodiment of a local area network, a wide area network, or any other form of a communications link.

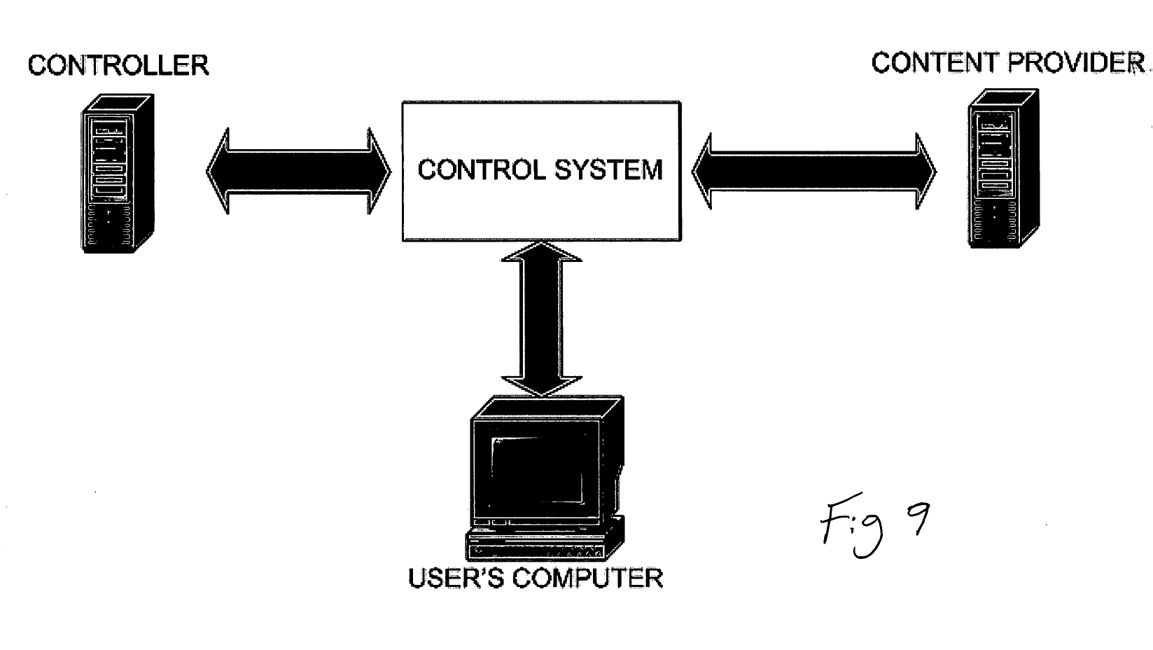

In another embodiment, shown in FIG. 9, the signal authorizing access uniquely identifies the user 618, the restricted content that the user 618 is authorized to access, the content provider 742 where the restricted content resides, and any other restrictions placed on the authorization, such as a time limit. Information corresponding to this signal also remains on the controller. The content provider and the controller have a prearranged communications protocol, acting on the communications link that allows the content provider to obtain authorization information for a plurality of users. The controller may be designed to provide authorization information to a single content provider or to a plurality of content providers. Upon receipt of the authorization signal, the control system instructs the user's computer to request the restricted content from the content provider via the communications link. Along with this request, the user's computer passes a code indicating the user's identity. This code may take the form of a unique network address, such as an IP address, or a code that corresponds to the original authorization signal sent from the controller. Other methods of identity are possible and are obvious to one skilled in the art. When the content provider receives the request for restricted content, it uses the prearranged protocol to send a signal to the controller that identifies the restricted content being requested and the user that is requesting it. The controller responds with a signal that either authorizes access or denies access. If the access is authorized, the content provider transmits the requested content to the user's computer. The restricted content may take the form of interactive data that may contain a plurality of entry points to other restricted content. In this case, when the user invokes an entry point, the user's computer passes a code indicating the user's identity, just as was done for the initial request. The content provider again communicates with the controller, sending a signal identifies the restricted content being requested and the user that is requesting it. The controller responds with a signal that either authorizes access or denies access. If the access is authorized, the content provider transmits the requested content to the user's computer. If not, the request is denied. The content provider may allow the user to enter the unique indicia again and restart the process to obtain a new authorization signal from the controller to authorize access to the newly requested restricted content. Alternatively, the controller may send a signal to the control system to allow the user to enter the unique indicia.

FIG. 1 is one method for authenticating the validity of an inputted unique indicia 744. Once a user 618 initiates the authentication process 10, the user 618 inputs 14 the unique indicia 744. The unique indicia 744 is then associated 16 with the predetermined token 734 value. Inherent in this association 16 process is a determination 18 of whether or not the inputted unique indicia 744 is valid. If it is not, the authentication process denies the user access 24 and ends 26. If, however, the indicia is valid, a determination is made as to whether the value of the token is greater than zero. If not, the authentication process denies the user access 24 and ends 26. Alternatively, the authentication process 10 may prompt the user 618 to input a second unique indicia 744. In yet another embodiment, the authentication process 10 may give the user 618 the option of inputting a credit card number to increase the value of the token 734. The authentication process includes, when required, checking any additional restrictions that the content provider places on access to their content, such as age or geographic location. This is done because certain unique indicia are associated with certain class of users. This additional restriction verification step may be performed during the indicia validation determination 18.

During the authentication process 10, a user 618 may be presented with payment options. For example, a user 618 may select to pay based upon a per-minute, per-day, per-week, per-month, or per-transaction basis. Examples of transactions include print commands, download and save commands, view commands, and other user initiated commands. If the user does not agree to the rates or terms presented, access will be denied. In addition, the terms or rates may change dynamically, for example, the user downloads files during peak usage times or access premium content.

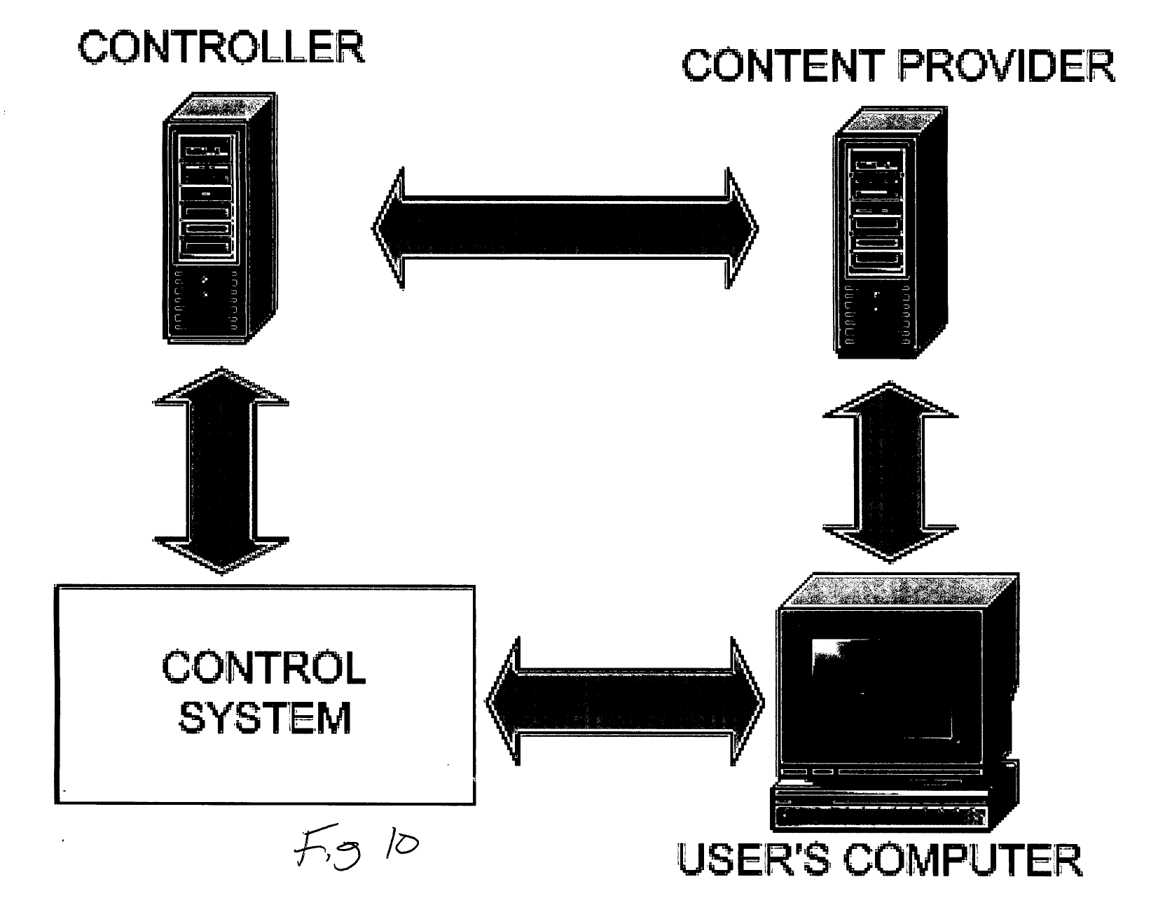

FIG. 10 is a schematic representation of an alternative embodiment of the authentication process 10. This alternative embodiment retrieves restrictions associated with the token based on information given at the time of purchase, such as age or geographic location. Other restrictions may be associated with the token that could be based on demographic data of the purchaser or the type of token purchased. On the schematic, these restrictions are retrieved and enumerated as 1 through N for N restrictions retrieved. When content is requested, it must satisfy all of these restrictions for the content to be presented to the user. After the user is granted access, various events could occur that will require additional value to be subtracted from the token, or a new indicia to be entered. Examples of such events are the invocation of entry points to other restricted content within the original content retrieved or time running out if the original content featured a restriction on amount of time available to view the content. Other events are being considered and can be appreciated by one skilled in the art.

The control system also has the ability to monitor the user's 618 content usage and transmit information representing that usage to the controller 732. In turn, the controller 732 updates the value of the token 734. Once the value of the token 734 becomes equal to or less than zero, the control system terminates the user's access to the content (see 23 in FIG. 1). Optionally, the control system may prompt the user 618 to enter a second unique indicia 744. In one embodiment, the control system makes a determination every second as to whether the user 618 is still viewing restricted content. This information is then recorded by the control system and sent to the controller 732 every minute. Alternative methods for monitoring usage are contemplated. For example, usage information may be transmitted in real time directly to the controller 732.

Users may employ the present invention to access the restricted content of multiple content providers. For instance, a user may use one token to access the restricted Internet content of several unrelated content providers. In this way, the present invention presents the ability to view subscription content on a pay-per-use basis, which translates into the user's ability to get what they want without anything extra.

Content providers may chose to enable access in accordance with the present invention for a variety of reasons, including market augmentation and accounting cost reduction. Through market augmentation, content providers can generate significant additional revenue by allowing non-subscribers to access their subscription content. This enables pay-per-use access for users and content providers who may not have provided such access previously.

Further benefits of the present invention include accounting and equipment cost reductions, as content providers only have to store one account entry for all of the users of the present invention. The company 612 performs all required accounting functions including usage tracking for each user and content provider. At predetermined intervals, a content provider receives a single payment for all users accessing that content provider's restricted content. This reduces transaction processing fees and administration costs.

The present invention may also be used to implement anonymous e-mail. For example, the company 612 may use the unique indicia to create an anonymous e-mail address under a domain controlled by the company 612. This anonymous e-mail address may then be linked to a user's 618 permanent e-mail address. Such a link may be stored and resolved only within a secure controller. This functionality enables users to supply an e-mail address that is valid but terminable at anytime. In this manner, the user's permanent e-mail address becomes less susceptible to spam e-mail and other inconveniences.

USER CHARACTERISTIC VERIFICATION SYSTEMS AND METHODS. The present invention also relates to systems and methods for verifying a user characteristic. Some content is intended only for users possessing a certain predetermined user characteristic or set of user characteristics. Representative examples of user characteristics include residence, age, affiliation, and geographic location. Age is a user characteristic that content providers often seek to verify prior to granting access to restricted content. Many attempts at effective age verification have been made. One existing method requires a user to first enter a credit card number before gaining access to restricted Internet content. This method is premised on the idea that only individuals age 18 or older have access to a credit card. Unfortunately, individuals younger than 18 do in some instances have access to a credit card, possibly their own or possibly someone else's credit card.

The present invention provides a method and system for verifying a user characteristic prior to allowing access to restricted content. One embodiment of the invention is a method comprising the following steps: distributing a restricted physical token having an anonymous access code thereon and a predetermined monetary value; receiving proof of a predetermined user characteristic; and providing the restricted physical token to a user after receiving proof of the predetermined user characteristic.

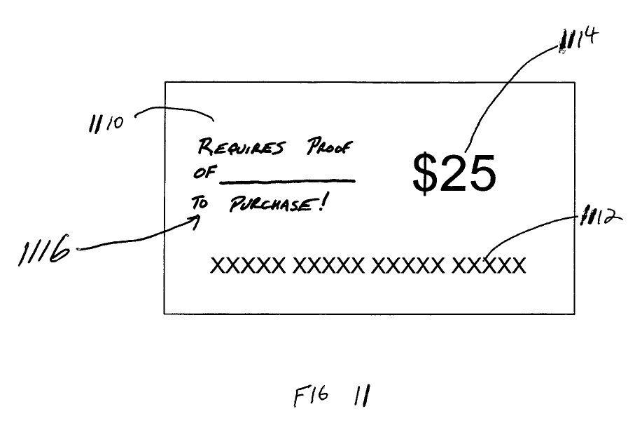

Control of access to restricted content is preferably accomplished by distributing a restricted physical token having an access code thereon and predetermined monetary value. In one embodiment, the token is in the form of a card, similar to both prepaid phone cards and shopping mall gift cards. FIG. 11 is a schematic representation of such a restricted card 1110 having an access code 1112. The access code optionally may be anonymous. The card 1110 also comprises a predetermined monetary value. That value may be represented on the card by a value indicator 1114. Alternatively, the physical token could be in the form of a computer printout having an access code imprinted thereon at the point of sale. Additional embodiments of the physical token are contemplated and can be appreciated by one of ordinary skill in the art. Preferably, each access code is unique. The physical token may also further comprise a restricted sale notice 1116 on its face.

The tokens are distributed in various restricted forms that require the presentation of proof of a predetermined user characteristic prior to providing the physical token to a user. The tokens may also be conditioned upon proof of a plurality of user characteristics. Representative examples of user characteristics include residence, age, affiliation, and geographic location. In one embodiment of the present invention, cards 1110 are used to control access of restricted Internet content. The term restricted can include restrictions based upon residence, age, affiliation, geographic location, or any other appropriate user characteristic.

Cards 1110 may be used to control access to content appropriate only for individuals that are a certain age. Multiple varieties of cards 1110 are also currently contemplated. For example, the sale of one variety of restricted cards may be restricted to individuals that are eighteen or older while others may be limited to individuals sixty-five or older. These restricted cards 1110 may be distributed at retail stores in a manner similar to that of the distribution of restricted items, such as tobacco products. A user seeking a restricted card 1110 must first provide evidence that they are of a predetermined age before the card will be distributed. For example, a user may be required to present a store clerk with a driver's license evidencing their age. This “carding” age verification technique has long been recognized as effective and efficient.

Once a user characteristic has been verified, the card's 1110 access code 1112 is used to access restricted content. The user may use a personal computer to access content from a content provider. The user will first initiate an authentication process through which the access code 1112 is verified. This can be accomplished by requiring the user to input the access code 1112 into a computerized system. Alternative methods of communicating the access code 1112 to the computerized system such as through the use of an iButton® computer chip or a smart card are contemplated and can be appreciated by one of ordinary skill in the art. The computerized system may take many forms including a custom Internet browser or viewer application installed upon the users computer, a control agent residing on the users computer, an Internet portal or other remote website, or software application accessible via the content providers website.

The access code 1112 is then verified. In one preferred embodiment, this is accomplished by ensuring a match between the inputted access code and a list or table of access codes accessible to the computerized system. Assuming the access code is valid and that the access code is authorized for the appropriate restriction(s), the computerized system will allow the user to access the restricted content.

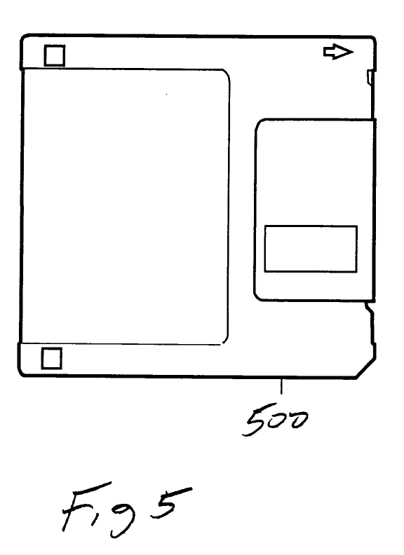

FIG. 5 shows an embodiment of the invention described above tangibly embodied in a computer program residing on a computer-readable medium or carrier 500. Other appropriate machine readable storage mediums include fixed hard drives, optical discs, magnetic tapes, semiconductor memories, such as read-only memories (ROMs), programmable (PROMs), etc. The medium 500 containing the computer readable code is utilized by executing the code directly from the storage device, or by copying the code from one storage device to another storage device, or by transmitting the code on a network for remote execution. The medium 500 may comprise one or more of a fixed and/or removable data storage device such as a floppy disk or a CD-ROM, or it may consist of some other type of data storage or data communications device. The computer program may be loaded into a memory to configure a computer processor for execution. The computer program comprises instructions which, when read and executed by the processor causes the processor to perform the steps necessary to execute the steps or elements of the present invention.

Thus while preferred embodiments of the invention have been described herein, variations in the design may be made, and such variations may be apparent to those skilled in the art of computer and computer network system design and implementation, as well as to those skilled in other arts. The specific embodiments identified above are by no means the only embodiments suitable for practice of the inventions, and substitute components and systems will be readily apparent to one skilled in the art. The scope of the invention, therefore, is only to be limited by the following claims.

What is claimed is:

1. A method for augmenting subscription content information service services with pay-per-use services, comprising the steps of:
providing content to a first user on a subscription basis; and
providing content to a second user on a pay-per-use basis by:
accepting a user token from the second user, the token having a unique indicia and a monetary value;
providing content to the second user responsive to the token unique indicia and monetary value; and
reducing the monetary value of the token based upon a value of the content provided to the second user.

2. The method of claim 1, wherein the step of providing subscription content responsive to the token unique indicia and monetary value further comprises the steps of:
associating the unique indicia with the monetary value;
determining whether or not the unique indicia is valid;
if the unique indicia is not valid then denying the second user access to subscription content;
if the unique indicia is valid then determining a monetary value amount; and
denying or granting access to the second user to the subscription content responsive to the monetary value amount.

3. The method of claim 2, wherein the step of denying or granting access responsive to the monetary value amount comprises the steps of:
if the monetary value amount is greater than zero is greater than zero then providing subscription content to the second user responsive to the token unique indicia and monetary value;
if the monetary value is not greater than zero, then prompting the second user access to input a credit card number to increase the monetary value of the token.

4. The method of claim 2, wherein the step of determining whether or not the unique indicia is valid further comprises the step of determining an additional restriction parameter chosen from the group consisting of user age and user geographic location.

5. The method of claim 3, wherein the step of providing subscription content further comprises the steps of:
presenting at least one per-use payment basis option chosen from the group consisting of a per-minute basis, per-day basis, per-week basis, per-month basis, and per-transaction basis; and
the user selecting at least one of the at least one per-use payment basis option.

6. The method of claim 1, further comprising the steps of:
providing premium subscription content to the second user on a pay-per-use basis, said premium subscription content not accessible responsive to the token unique indicia;
providing premium subscription content access requirements to the second user;
the second user agreeing to the premium subscription content access requirements and receiving premium token indicia;
providing premium subscription content to the second user responsive to the premium token indicia and the monetary value; and
reducing the monetary value of the token based upon a premium value of the premium subscription content provided to the second user.

7. The method of claim 1, further comprising the steps of:
providing a purchase interface to the second user;
selling one of the group consisting of additional monetary value and premium token indicia to the user;
associating the sold one of the group consisting of additional monetary value and premium token indicia with the token.

8. The method of claim 1, wherein the step of providing content to a second user on the pay-per-use basis comprises providing content by an internet browser interface, further comprising the steps of:
placing an intermediary token entity link on an area of a subscription content website;
redirecting the second user to the intermediary token entity responsive to the second user engaging the intermediary token entity link;
the intermediary token entity providing the user token having the unique indicia and monetary value to the second user.

9. The method of claim 1, wherein the step of providing content to a second user on the pay-per-use basis comprises providing content by an internet browser interface, further comprising the steps of:
associating a domain lookup process with access of a subscription content website by the second user;
redirecting the second user to an intermediary token entity website through the domain lookup process responsive to the second user engaging the subscription content website;
the intermediary token entity providing the user token having the unique indicia and monetary value to the second user responsive to interaction of the second user with the intermediary token entity website.
